(19) United States
(12) Patent Application Publication
(10) Pub. No.: US 2010/0230495 A1
(43) Pub. Date: Sep. 16, 2010

(54) PROCESS FOR THE CREATION OF A UNIQUE IDENTIFICATION CODE, MEANS TO CREATE A UNIQUE IDENTIFICATION CODE, UNIQUE IDENTIFICATION CODE OBTAINED AND USE OF THE UNIQUE IDENTIFICATION CODE

(75) Inventor: Yvan ERBS, Puerto-Juarez (MX)

Correspondence Address: DAVIS & BUJOLD, P.L.L.C., 112 PLEASANT STREET, CONCORD, NH, 03301, US

(73) Assignee: GEO-U L.L.C., Newark, DE (US)

(21) Appl. No.: 12/401,902

(22) Filed: Mar. 11, 2009

(51) Int. Cl. G06K 19/00

(52) U.S. Cl. 235/487; 235/375

(57) ABSTRACT

The present invention relates to a process for the creation of a unique identification code that corresponds to a natural person, legal entity, or point of interest, characterized in that the said identification code is obtained by creating a unique nominal identifier that corresponds to a unique geographic identifier which is made up of a longitude and latitude of a geographic site corresponding to the location of a residence of a natural person, legal entity or point of interest identified by the said identification code.

### TECHNICAL SCOPE

The present invention relates to a process for the creation of a unique identification code that corresponds to a natural person, legal entity, or point of interest.

The invention also relates to means to create a unique identification code that corresponds to a natural person, legal entity, or point of interest.

The invention also relates to the unique identification code that corresponds to a natural person, legal entity, or point of interest, obtained using the said means.

The invention moreover relates to at least one use of the said unique identification code that corresponds to a natural person, legal entity, or point of interest.

### PRIOR TECHNIQUE

The identification of a natural person, legal entity for any kind of organisation, or point of interest which can be defined as an object or location that presents one or more characteristics, either historical, architectural, geographical or similar, is usually performed by combining a certain number of data which are particular to them. Traditionally, these data include the family name, or a corporate name, or an official designation that corresponds for example to the information recorded in registers or official document files such as identity cards, driver's licences, etc., in accordance with the national rules of the residence of a natural person or registered office of a company. These data are usually supplemented by a postal address. The combination of a name which is an official designation for a natural person, economic entity, or point of interest, allows the said person, said legal entity, or said point of interest to be located, and to have a correspondence or information sent to it, to find it, or any kind of communication to be forwarded to it, via postal mail or electronically.

The first observation one can make is that the rules differ from one country to the next, which complicates and sometimes makes impossible the normal delivery of a correspondence, or the search of a point of interest. In some cases, it is necessary for a sender to enquire about the customs or practices in force in order to prevent the loss of the said correspondence. The second observation is that there is no universal system that allows a person or legal entity to be identified, whatever the territory of the person sending a communication or consignment and whatever the territory of the recipient. The third observation is that private postal systems are multiplying and developing effectively, despite still relying on the same traditional identification principle that uses the name and so-called postal address. Every existing solution requires the transcription, either manual or via computer entry, of all the identification data of a sender and of a recipient, therefore generating a risk of errors. No solution allows this risk to be circumvented.

### DESCRIPTION OF THE INVENTION

The present invention proposes to overcome the disadvantages of known identification methods based on the name and so-called postal address, the form and presentation of which depend on the territories of use, by creating a universal identification code designed to be used throughout the world for various applications, by minimising the information to be retranscribed so as to avoid the risk of errors and improve processing time.

For this purpose, the process for the creation of a unique identification code as mentioned in the preamble is characterized in that the said identification code is obtained by creating a unique nominal identifier that corresponds to a unique geographic identifier.

Thus, the entry or retranscription of the sole unique identification code, which may be a single word for example, allows a natural person, legal entity or location, notably its postal address, to be identified and very precisely targeted.

According to a preferred embodiment, the said unique geographic identifier is made up of the longitude and latitude of a geographic site.

Advantageously, the said geographic site corresponds to the localization of a residence of a natural person, identified by the said identification code or to the localization of a legal entity identified by the said identification code or to the localization of a point of interest identified by the said identification code.

To this end also, the said device used to create a unique identification code corresponding to a natural person, legal entity, or point of interest, is characterized in that it comprises means to generate a geographic identifier, and to allow it to be assigned a nominal identifier, either fanciful, patronymic or that corresponds to a corporate name.

In a particularly advantageous way, the said means used to generate a unique geographic identifier include equipment to define the longitude and latitude of a geographic site.

To this end, the unique identification code that corresponds to a natural person, legal entity, or point of interest, is characterized in that the said identification code consists of a unique nominal identifier that corresponds to a unique geographic identifier.

Advantageously, the said unique geographic identifier is made up of the longitude and latitude of a geographic site.

Lastly, a first application of the said identification code is characterized in that it is dedicated to the delivery of a postal type consignment, in which one establishes a central organisation that comprises a unit which is in contact with the sender and a unit which is in contact with the recipient, in which the sender and the recipient each have a unique identification code and in which, at the time of sending, the sender and the recipient agree on a mode of distribution upon receipt of the consignment.

In a particularly advantageous way, the said mode of distribution is of two types: (a) the recipient's unit is in charge of keeping the mail in a distribution centre until the recipient collects it or (b) the recipient's unit is in charge of delivering the mail or parcel at the recipient's address.

Lastly a second application of the said identification code is characterized in that it is dedicated to the geographic localization of the unique identification code of a first user by a second user by entering the unique code of the first user in a mapping application accessible via the Internet and the corresponding public password if the first user has created one, to display the longitude X and latitude Y linked to the identification code of the said first user and to locate the corresponding geographic position on a map.

### BRIEF DESCRIPTION OF THE DRAWINGS

The present invention and its advantages will be better understood upon reading of the detailed description of several embodiments of the device, designed to implement the process of the invention, in reference to the annexed drawings given as non limiting examples, in which:

FIG. 1 is a schematic view representing the principle for the creation of a unique identification code according to the invention and a list of applications for this identification code,

FIG. 2 is a schematic view representing a first specific use of the said identification code.

FIG. 3 is a schematic view representing a second specific use of the said identification code.

### ILLUSTRATIONS OF THE INVENTION

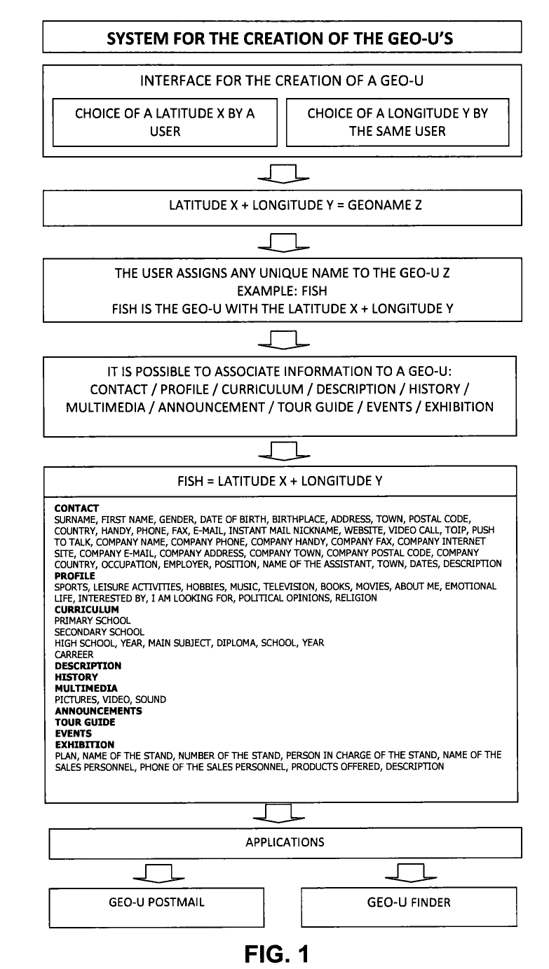

In reference to FIG. 1, the process for the creation of a unique identification code according to the invention includes a first stage which consists in defining a geographic location by its longitude X and latitude Y and to assign a denomination Z to this pair of data. Denomination Z can be completely fanciful or it can correspond to a family name, corporate name or any other official designation. The pair (X; Y) defines a unique geographic position designated by the holder of denomination Z. This denomination is unique and it is assigned to a user which is a natural person, legal entity, or point of interest, or similar, for a given period that may be extended on request. As an example, a user has decided to assign the designation “Fish” to a Longitude-Latitude pair: (X1, Y1). This designation shall be called the Fish “Geo-u” and shall correspond to the pair (X1, Y1).

It is possible to associate various information to a Geo-u, additional information that can be personal information when the Geo-u is linked to a natural person and/or associated information, professional or factual, when the Geo-u corresponds to a natural person or to a legal entity or to historical, environmental, or similar information when the Geo-u is a point of interest. The sets of information are notably classed by category: contact, profile, curriculum vitae, description, history, multimedia, announcements, tour guide, events, exhibition.

“Contact”, for example, includes information such as the surname, first name, gender, date of birth, birthplace, postal address, telephone numbers, fax numbers, e-mail addresses, corporate names of companies, addresses of registered offices, addresses of commercial buildings, data on the company's organisation, websites, information related to the company's activity, data on the accounting incomes, etc.

When the Geo-u corresponds to a natural person, the information can be supplemented by classed data, especially in a “Profile” category which may include elements such as the sports practiced, leisure activities, hobbies, favourite type of music, choice of books, movies, personal messages relating to the emotional life, political views, religion, etc.

A “Curriculum vitae” category may include data that correspond to the training and professional experience of a natural person, to the list of suppliers or customers of an industrial or commercial company.

A “multimedia” category may include photo albums, video recordings made by a natural person and presenting stages of the person's private or professional life, or to topics relating to an unspecified interest.

A “Description” category may describe the location, object, situation, material, or any other data describing the nature of the Geo-u.

A “History” category may include information relating to the history of the Geo-u.

An “Announcement” category may include various announcements in a specific format.

A “Tour Guide” category may include historical, descriptive, environmental, and sociological information about various locations with a common theme, and allow these locations to be discovered as part of a guided tour.

An “Event” category may describe, illustrate, or promote a specific event.

An “Exhibition” category may include information that allow the immediate localization of an exhibitor stand, an access plan, a situation of the stand, a position of the operator, and useful information such as the name of the person in charge of the stand, the name of the sales personnel, the identification of the objects on exhibition, etc.

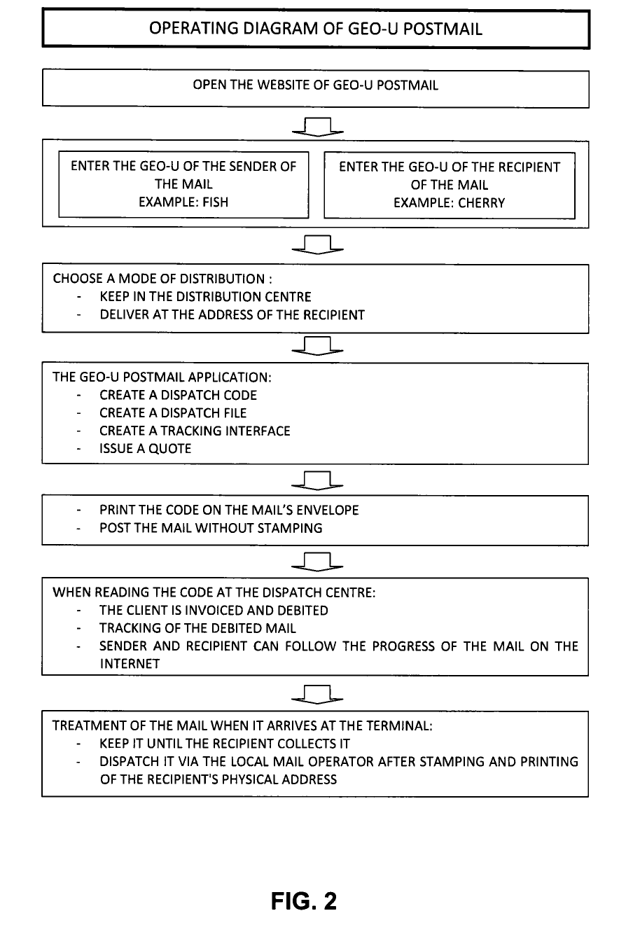

As an example, in the “Postmail” application represented in FIG. 2, it is necessary for the sender and recipient of a mail or any consignment, for example a postal parcel, to be users of Geo-u, i.e. both of them must have their own Geo-u. In addition, it is necessary to create a central organisation, called “Geo-u Postmail” for example, which includes a unit that is in contact with the sender and a unit that is in contact with the recipient. At the time the mail or parcel is sent, the sender and recipient must agree on a mode of distribution that can be of two types: (a) the recipient's Geo-u Postmail is in charge of keeping the mail in a distribution centre until the recipient collects it or (b) the recipient's Geo-u Postmail is in charge of delivering the mail or parcel at the recipient's address.

At the time a mail or parcel is to be sent to a recipient, the Geo-u Postmail interface creates a dispatch code as well as a dispatch file, a tracking interface and issues a quote. The dispatch code is printed on the mail's envelope or on the dispatched parcel and the object is posted without stamping from the sender's Geo-u Postmail unit. As soon as the dispatch code is read by the Geo-u Postmail unit of the sender, the letter is invoiced and debited. The tracking of the consignment starts, so that the sender as well as the recipient can follow the progress of the consignment on the Internet. Upon arrival of the consignment in the recipient's Geo-u Postmail unit, it is either kept until the recipient collects it or delivered by a local mail operator after stamping and printing of the recipient's postal address.

In this application, a consignment can be precisely tracked throughout its progress. Depending on the conditions in place in the country of the recipient, the latter can choose between a direct collection mode or a delivery mode via a local operator. This application requires complementary personal data linked to the Geo-u, but prevents errors in the transcription of the addresses and adapts to the situation in place in the territory where the consignment is received.

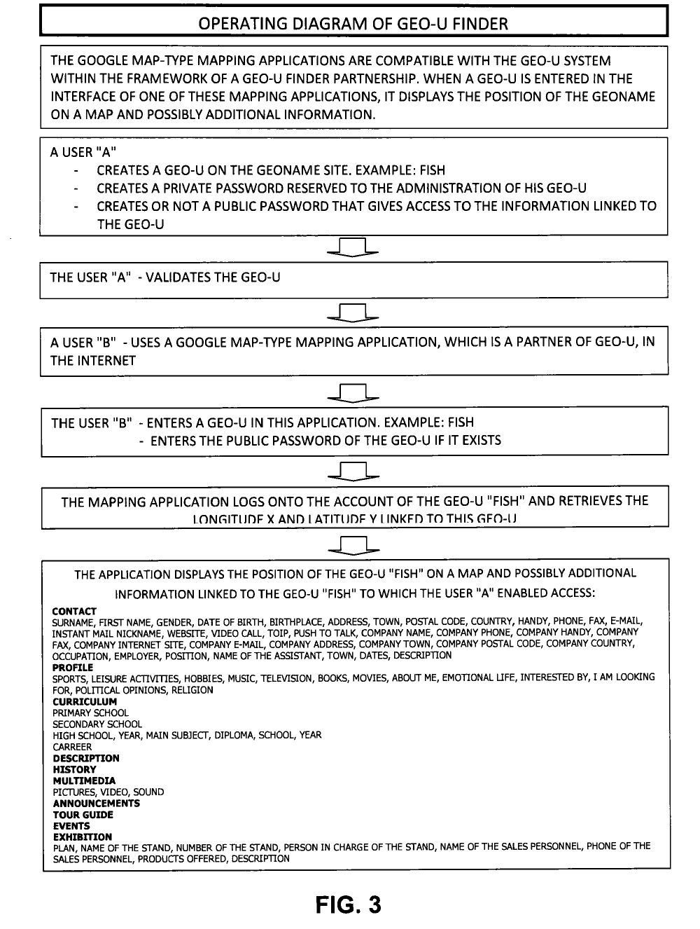

A second application called Geo-u Finder is illustrated by FIG. 3. This application may be made compatible using mapping interfaces so that the geographic coordinates that correspond to a Geo-u can be viewed on a geographic map. For a given user A who created his specific Geo-u, for example “fish”, which corresponds to a longitude X and a latitude Y, the application additionally consists in creating a private password reserved to the administration of his Geo-u and in creating a public password that gives access to the information linked to the Geo-u. At the end of these operations, user A validates his Geo-u.

A user B who wishes to locate the position of the “fish” Geo-u of user A or to view the information relating to this “fish” Geo-u enters the “fish” Geo-u of user A in a mapping application that can be accessed on the Internet, and enters the public password that corresponds to the “fish” Geo-u if user A has created one. The mapping application then logs onto the account of the “fish” Geo-u, retrieves the longitude X and latitude Y linked to this Geo-u and locates its geographic position on a map. If user A has integrated additional information such as those listed in FIG. 1, “Contact, Profile, Curriculum Vitae . . . ” and if he has enabled access to this information, user B can obtain all or part of this information when the position of the “fish” Geo-u is displayed on a map.

The private password allows access to the administration system of a Geo-u account, and modification of the data linked to this account. Any holder of a Geo-u must imperatively define a private password upon the creation of his unique Geo-u identification code.

The creator of a Geo-u can maintain open access to the information relating to his Geo-u. A user thus will just have to enter the Geo-u in an interface to gain direct access to the information relating to the corresponding Geo-u account. But the holder of a Geo-u account can also create a public password. Thus the additional information, such as those listed in FIG. 1, “Contact, Profile, Curriculum Vitae . . . ” will no longer be available to view without entering this public password. Only the localization of the Geo-u's position on a map will be possible by default.

When he enters additional information such as those listed in FIG. 1, “Contact, Profile, Curriculum Vitae . . . ”, the creator of a Geo-u must authorise this information so that it can be viewed by a user. The information that is not authorised appears on the account, but is not freely available for viewing.

As an example:

For a Geo-u: “fish” that corresponds to the geographic data: Latitude X and Longitude Y, the relating information is:

surname: Sylvie (authorised information)

first name: Faldi (unauthorised information)

without a public password

If a user enters the “fish” Geo-u on a mapping interface, the application will locate this Geo-u on a map, only with the surname comment: Sylvie.

The present invention is not limited to the embodiments described as non limiting examples, but extends to any development that remains within the field of acquired knowledge of the person skilled in the art without departing from the scope of protection, as defined in the annexed claims.

1-18. (canceled)

19. A process for the creation of a unique identification code that corresponds to one of a natural person, a legal entity, or a point of interest, the process comprising the step of obtaining the identification code by creating a unique nominal identifier that corresponds to a unique geographic identifier.

20. The process according to claim 19, further comprising the step of making up the unique geographic identifier from a longitude and a latitude of a geographic site.

21. The process according to claim 19, further comprising the step of corresponding the geographic site to a location of a residence of a natural person identified by the identification code.

22. The process according to claim 19, further comprising the step of corresponding the geographic site a location of a legal entity identified by the identification code.

23. The process according to claim 19, further comprising the step of corresponding the geographic site a location of a point of interest identified by the identification code.

24. A device used to create a unique identification code corresponding to a natural person, a legal entity, or a point of interest, wherein the device comprises means for generating a geographic identifier and for assigning a nominal identifier, either fanciful, patronymic or that corresponds to a corporate name.

25. The device according to claim 24, wherein the means used for generating the unique geographic identifier includes equipment to define a longitude and a latitude of a geographic site.

26. The device according to claim 24, wherein the geographic site corresponds to the location of a residence of a natural person identified by the identification code.

27. The device according to claim 24, wherein the geographic site corresponds to the location of a legal entity identified by the identification code.

28. The device according to claim 24, wherein the geographic site corresponds to the location of a point of interest identified by the identification code.

29. A unique identification code which corresponds to a natural person, a legal entity, or a point of interest, wherein the identification code consists of a unique nominal identifier that corresponds to a unique geographic identifier.

30. The unique identification code according to claim 29, wherein the unique geographic identifier is made up of a longitude and latitude of a geographic site.

31. The unique identification code according to claim 29, wherein the geographic identifier corresponds to a location of a residence of a natural person identified by the said identification code.

32. The unique identification code according to claim 29, wherein the geographic identifier corresponds to a location of a legal entity identified by the identification code.

33. The unique identification code according to claim 29, wherein the geographic identifier corresponds to a location of a point of interest identified by the identification code.

34. An application of the identification code according to claim 29, wherein the application is dedicated to delivery of a postal type consignment, in which one establishes a central organization that comprises a unit which is in contact with a sender and a unit which is in contact with a recipient, in which the sender and the recipient each have a unique identification code and in which, at a time of sending, the sender and the recipient agree on a mode of distribution upon receipt of the consignment.

35. The application of the identification code according to claim 34, wherein the distribution mode is of two types:
(a) the recipient's unit is in charge of keeping the mail in a distribution center until the recipient collects the mail, or
(b) the recipient's unit is in charge of delivering the mail or parcel at the recipient's address.

36. The application of the identification code according to claim 29, wherein the application is dedicated to localization of the unique identification code of a first user (A) by a second user (B), in which the second user (B), who wishes to locate the unique identification code of the first user (A), enters a code of this user in a mapping application accessible via the Internet, enters a corresponding public password, to display longitude X and latitude Y linked to the identification code of the first user (A) and to locate the corresponding geographic position on a map.
